(19) United States
(12) Patent Application Publication
(10) Pub. No.: US 2009/0193416 A1
(43) Pub. Date: Jul. 30, 2009

(54) DECIDABILITY OF REACHABILITY FOR THREADS COMMUNICATING VIA LOCKS

(75) Inventor: Vineet Kahlon, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/354,165

(22) Filed: Jan. 15, 2009

Related U.S. Application Data
(60) Provisional application No. 61/023,114, filed on Jan. 24, 2008.
(60) Provisional application No. 61/101,755, filed on Oct. 1, 2008.

(51) Int. Cl. G06F 9/46

(52) U.S. Cl. 718/100

(57) ABSTRACT

A system and method for deciding reachability includes inputting a concurrent program having threads interacting via locks for analysis. Bounds on lengths of paths that need to be explored are computed to decide reachability for lock patterns by assuming bounded lock chains. Reachability is determined for a pair of locations using a bounded model checker. The program is updated in accordance with the reachability determination.

### RELATED APPLICATION INFORMATION

This application claims priority to provisional application Ser. No. 61/023,114 filed on Jan. 24, 2008 and provisional application Ser. No. 61/101,755 filed on Oct. 1, 2008, both incorporated herein by reference.

### BACKGROUND

1. Technical Field

The present invention relates to dataflow analysis in concurrent programs and more particularly to systems and methods for deciding location reachability and determining locations affected by other threads in concurrent programs.

2. Description of the Related Art

Dataflow analysis is an effective and indispensable technique for analyzing large scale real-life sequential programs. For concurrent programs, however, it has proven to be an undecidable problem. This has created a huge gap in terms of the techniques required to meaningfully analyze concurrent programs (which must satisfy the two key criteria of achieving precision while ensuring scalability) and what the current state-of-the-art offers.

A key obstacle in the data flow analysis of concurrent programs is to determine for a control location l in a given thread, how the other threads could affect dataflow facts at l. Equivalently, one may view this problem as one of precisely delineating transactions, i.e., sections of code that can be executed atomically, based on the dataflow analysis being carried out. The various possible interleavings of these atomic sections then determine interference across threads.

The challenge in analyzing multi-threaded programs, therefore, lies in delineating transactions accurately, automatically and efficiently. Suppose that we are interested in the aliases of a shared pointer sh at location l in thread T of a given concurrent program. Then, sh could be modified at multiple locations in other threads each of which could potentially contribute to aliases of sh at l. If we let all statements modifying sh in other threads contribute aliases then the aliasing information often turns out to be too coarse to be useful. This is because concurrent programs usually do not allow unrestricted interleavings of local operations of threads.

Synchronization primitives are typically inserted to restrict interleavings. In order for the computed aliases to truly reflect program behavior, synchronization-induced scheduling constraints need to be taken into account when delineating transactions. Thus, in delineating transactions, we need to take into account scheduling constraints imposed by synchronization primitives. The problem of synchronization-based transaction delineation is intimately connected with the problem of deciding pairwise reachability. In a global state g, a context switch is required at location l of thread T where a shared variable sh is accessed only if starting at g, some other thread currently at location m can reach another location m′ with an access to sh that conflicts with l, i.e., l and m′ are pairwise reachable from l and m. In that case, we need to consider both interleavings wherein either l or m′ is executed first thus requiring a context switch at l.

Thus a key problem underlying dataflow analysis of concurrent programs is to decide pairwise reachability for threads with recursive procedures that communicate using the standard synchronization primitives like locks and wait/notifies (broadcasts are hard to find in real code).

Pairwise reachability was shown to be decidable for threads interacting via nested locks. However, even though the use of nested locks remains the most popular paradigm there are niche applications, like databases, where lock chaining is required. Lock chaining is an essential tool that is used for enforcing serialization, particularly in database applications. For instance, the two-phase commit protocol which lies at the heart of serialization and recovery in databases uses lock chains of length 2. Lock chaining is also very useful in traversing data structures like trees or linked lists. Instead of locking the entire data structure, with a single mutex and thereby preventing any parallel access each node or lock has a unique mutex. Another classic example where non-nested locks occur frequently are programs that use both mutexes and Wait/Notify statements. In Java and the Pthreads Library, Wait/Notify statements require the use of mutexes on the objects being waited on. These mutexes typically interact with existing locks in code to produce non-nesting. Existing techniques cannot be used to reason about such non-nested or even nested recursive locks.

Deciding reachability of two control locations in two different threads of a concurrent program is a key problem with broad applications including data race detection, dataflow analysis, etc., which are used in the analysis and verification of concurrent software, e.g., device drivers, network protocols, etc. For concurrent programs where threads could have recursive procedures, reachability is undecidable, i.e., does not have an algorithmic solution. However, in order to effectively analyze concurrent programs, it is critical that we develop precise and scalable solutions for deciding reachability. Prior techniques attempt to solve the reachability problem by converting the problem to the language intersection problem for bounded languages which is decided via Integer linear programming.

### SUMMARY

Dataflow analysis for concurrent programs is a problem of critical importance but, unfortunately, also an undecidable one. A key obstacle is to determine precisely how dataflow facts at a location in a given thread could be affected by operations of other threads. This problem, in turn, boils down to pair-wise reachability, i.e., given program locations c₁ and c₂ in two threads T₁ and T₂, respectively, determining whether c₁ and c₂ are simultaneously reachable in the presence of constraints imposed by synchronization primitives. Unfortunately, pairwise reachability is undecidable, in general, even for the most commonly used synchronization primitive, i.e., mutex locks. We, however, exploit the fact that almost all lock usage patterns in real life programs result in bounded lock chains. Chaining occurs when the scopes of two mutexes overlap. When one mutex is required the code enters a region where another mutex is required. After successfully locking that second mutex, the first one is no longer needed and is released. Lock chaining is an essential tool that is used for enforcing serialization, particularly in database applications. Existing techniques cannot be used to reason about such non-nested or even nested recursive locks, but only finitely many nested locks.

For concurrent programs with bounded lock chains, we show that pairwise reachability becomes decidable. Towards that end, we formulate small model properties that bound the lengths of paths that need be traversed to reach a given pair of control states. Apart from being of theoretical interest, small model properties permit us to reduce pairwise reachability for threads, even those with recursive procedures, to model checking a finite state system thereby permitting us to leverage existing powerful state space exploration techniques.

Importantly, our new results provide a more refined characterization for decidability of pairwise reachability, in terms of boundedness of lock chains rather than nestedness of locks. Since nested locks are a special case, i.e., chains of length zero, this narrows the decidability gap for pairwise reachability in threads interacting via locks.

A system and method for deciding reachability includes inputting a concurrent program having threads interacting via locks for analysis. Bounds on lengths of paths that need to be explored are computed to decide reachability for lock patterns by assuming bounded lock chains. Reachability is determined for a pair of locations using a bounded model checker. The program is updated in accordance with the reachability determination.

A system for deciding reachability includes a concurrent program having at least one pair of locations in two threads interacting via locks. A processor receives the concurrent program for analysis. The analysis includes computing bounds on lengths of paths that need to be explored to decide reachability for nested and non-nested lock patterns. A bounded model checker is configured to determine reachability for the pair of locations. A user interface is configured to update the concurrent program and repair bugs in accordance with a reachability determination.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of a system/method for determining reachability based on threads interacting based on locks in accordance with one embodiment;

FIG. 2 is an example program and its lock causality graph for demonstrating the present principles;

FIG. 3 is an illustratively program employed to compute a lock causality graph for a pair of sequences on lock/unlock statements;

FIG. 4 is a block/flow diagram of a system/method for determining reachability based on threads interacting based on locks in greater detail in accordance with one embodiment; and

FIG. 5 is a block diagram of a system for determining reachability based on threads interacting based on locks in accordance with one embodiment.

### DETAILED DESCRIPTION OF PREFERRED EMBODIMENTS

Pairwise reachability is decidable not only for threads interacting via nested locks but also non-nested locks forming bounded lock chains and recursive nested locks. These lock usage patterns cover all the cases encountered in real-life programs. To show decidability, we formulate a small model property for pairwise reachability that bounds the lengths of paths that need to be traversed in order for a given pair of control states (c₁,c₂) to be reachable. Apart from being of theoretical interest, small model properties permit us to reduce pairwise reachability for threads, even those with recursive procedures, to model checking a finite state system thereby allowing us to leverage existing powerful state space exploration techniques.

While performing bounded model checking the state space of a program need only be unrolled up to the depth formulated by the small model property. This enables us to leverage the use of powerful symbolic techniques that have been developed for exploring finite state system and which do not extend easily to recursive programs that in general have infinitely many states.

The present techniques also narrow the known decidability/un-decidability divide for pairwise reachability. The state-of-the-art characterization of decidability versus undecidability for threads interacting via locks was in terms of nestedness versus non-nestedness of locks. We show that decidability can be re-characterized in terms of whether the lengths of lock chains in the given program are bounded or not. Since nested locks form chains of length zero, our results are more powerful than the existing ones. Thus, our new results narrow the decidability gap by providing a more refined characterization for the un-decidability of pairwise reachability in threads.

Methods for deciding reachability are provided by showing a small model property, i.e., if a state is reachable it is in fact reachable via a computation of a bounded size. Then, it is sufficient to explore only paths with lengths up to this bounded size. An important advantage of this technique is that even for threads with recursive procedures, which potentially have infinitely many states, we can reduce checking reachability to a finite state system.

The present solution is more efficient than conventional ones which use bounded languages. Moreover, the small model property reduces the reachability problem for concurrent programs with threads that could have recursive procedures to checking reachability in a finite state system which then permits leveraging existing powerful state space exploration techniques that cannot be applied directly on recursive programs. This enhances the scalability of our approach.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

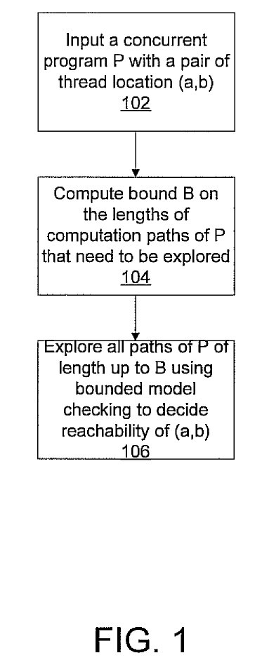

Referring now to the drawings in which like numerals represent the same or similar elements and initially to FIG. 1, a block/flow diagram shows a system/method for deciding reachability in accordance with one embodiment. In block 102, a concurrent program P having a pair of thread locations (a,b) is input to an analyzer for checking reachability in accordance with the present principles. In block 104, a bound B is computed along the lengths of computation paths of P that need to be explored. In block 106, explore all paths of P of length up to B using bounded model checking to decide reachability of (a,b). Further details of this system/method will be described hereinafter.

System Model: Consider concurrent programs comprised of threads that communicate with each other using shared variables and synchronization primitives. Each thread is represented by means of its control flow graph (CFG). Of the standard synchronization primitives, locks are the most widely used. Wait/Notify (Rendezvous) find use in niche applications like web services, e.g., web servers like Apache and browsers like Firefox; and device drivers, e.g., autofs. Broadcasts are extremely rare and hard to find in open source code. We consider only concurrent programs comprised of threads communicating via shared variables and synchronizing via locks and Wait/Notify for simplicity.

Locks. Locks are standard primitives used to enforce mutually exclusive access to shared resources.

Wait/Notify (Rendezvous). Wait/Notify primitives are supported in Java and standard thread libraries like Pthreads. The Wait/Notify statements of a thread Tᵢ are represented as transitions labeled with notify and wait actions of the form a↑ and b↓, respectively. A pair of transitions labeled with l↑ and l↓ are called matching. A wait transition tr₁:

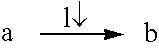

of a threat Tₗ is enabled in global state s of a concurrent program if there exists a thread Tⱼ other than Tᵢ, in local state c such that there is a matching notify transition of the form tr₂:

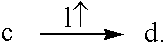

In order to execute the wait transition, both the wait and notify transitions tr₁ and tr₂ must be fired synchronously with Tᵢ and Tⱼ transiting to b and d, respectively, in one atomic step. The notify (send) statement, on the other hand, is non-blocking, i.e., can always execute irrespective of whether a matching wait statement is currently enabled or not. We focus on thread interacting via locks.

Dataflow Analysis of Concurrent Programs: Nested Pushdown Systems: A simple strategy for dataflow analysis of concurrent program includes three main steps (i) compute the analysis-specific abstract interpretation of the concurrent program, (ii) delineate the transactions, (iii) compute dataflow facts on the transition graph resulting by taking all necessary interleavings of the transactions. Pushdown systems (PDSs) provide a natural framework for modeling abstractly interpreted threads. A PDS has a finite control part corresponding to the valuation of the local variables of the procedure it represents and a stack which provides a means to model recursion.

Formally, a PDS is a five-tuple P=(Q,Act,Γ,c₀,Δ), where Q is a finite set of control locations, Act is a finite set of actions, Γ is a finite stack alphabet, and Δ⊂(Q×Γ)×Act×(Q×Γ*) is a finite set of transition rules. If ((p,γ),a,(p′,w))εΔ then we write

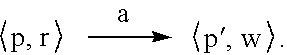

A configuration of P is a pair [symbol] p,w [symbol] , where pεP denotes the control location and wεΓ* the stack content. We call c₀ the initial configuration of P. The set of all configurations of P is denoted by C.

In constructing a (weighted-)PDS for an abstractly interpreted program, the primary role of the stack is to model function calls and returns. As a result only stack operations modeling function calls can push symbols to increase the height of the stack and only stack operations modeling function returns can pop operations that decrease the height of the stack. For any PDS, we may, without loss of generality, assume, each stack transition pushes exactly one stack symbol and pops exactly one stack symbol. This is because a stack transition pushing multiple symbols on to the stack, can be broken up into multiple stack transitions that push exactly one symbol via the introduction of intermediate control states. This ensures that along each computation of a PDS the symbol popped by a stack is precisely the last symbol that was pushed and that has not yet been popped. This permits us to clearly associate push and pop transitions with function calls and returns of the sequential program from which the PDS is constructed. Thus, each stack push transition modeling a function call fc is designated an fcₚᵤₛₕ transition. Analogously, any pop transition modeling a return of fc is designated an fcₚₒₚ transition. Note that there may exist many different calls to (syntactically) the same function from (i) different control locations, and (ii) with different dataflow facts. These are treated as different function calls, and are represented in the PDS by different push and pop transitions. The association of stack transitions with function calls and returns motivate the following simple definition.

Matched Call: Given a computation x of a nested PDS P, we say that an fcₚᵤₛₕ transition trᵢ:fcₚᵤₛₕ fired along x is matched by an fcₚₒₚ transition trⱼ=fcₚₒₚ where j>i if trⱼ pops the stack alphabet that was pushed by trᵢ (Note that there may exist transitions fired along x between trᵢ and trⱼ that pop the same alphabet as trⱼ but the one pushed by some other transition fired between trᵢ and trⱼ along x. These transitions are not considered to be matching for trₗ).

Nested Calls: Let trᵢ and trⱼ be push transitions that are matched by the pop transitions tr_{i′} and tr′ⱼ respectively, along x (if along x a matching pop transition does not exit for a push transition trₖ then we denote its matching pop transition by tr_{∞}). Then the push/pop pair (trⱼtr_{j′}) is nested within the push pop pair (trᵢ,tr_{i′}) if i<j and either i′=∞=j′ or j′<i′.

Non-Nested Calls: A pair (trᵢ,tr_{i′}) of matching push and pop transitions trᵢ and tr_{i′} fired along x is said to be non-nested if there does not exist another matching push/pop pair (trⱼ,tr_{j′}) such that (trᵢ,tr_{i′}) is nested within (trⱼ,tr_{j′}).

Sequential Small Model Property: To exhibit a small model property for control state reachability in sequential programs, we leverage the horizontal and vertical bounding lemmas. The horizontal bounding lemma limits the number of non-nested function calls that need to be fired along a computation to reach c. However, the horizontal bounding lemma does not limit the number of function calls that could be nested within each other. Bounding the call depth of functions is accomplished via the vertical bounding lemma. Combining these two lemmas then enables us to limit the total length of a computation path needed to reach a control state c. This immediately yields the desired sequential small model property.

Horizontal Reduction: The idea behind the horizontal reduction lemma is captured in a path transformation that we refer to as a horizontal reduction. If the same configuration occurs twice along a computation x as, say, xᵢ and xⱼ, then we can short-circuit the sub-computation from xₗ to xⱼ. Formally, let x=x₀ . . . xₙ be a computation sequence of P and let y be a computation of P that is also a subsequence of x then we say that y is gotten from x via a horizontal reduction if there exist configurations xᵢ and xⱼ, where i<j, such that configurations xᵢ and xⱼ are the same (both the control state and the stack content) and y=x₀ . . . xᵢxⱼ₊₁ . . . xₙ, where configurations xᵢ and xⱼ are the same.

Let trᵢ:xᵢ→xᵢ₊₁ be the first push transition fired along x and let tr_{i′}:x_{i′}→x_{i′+1} be the matching pop transition. Similarly, we let xᵢ be the first stack push transition occurring after x_{i′} along x and x_{j′} the matching pop transition corresponding to xⱼ. Note that, by definition of j, no stack transition can be fired along the sub-sequence x_{i′} . . . xⱼ. Continuing in this fashion, we see that x can be parsed as x=LₒN₀ . . . LₖNₖ, where Lᵢ is a (possibly empty) sequence of non-stack transitions and Nᵢ is a sequence resulting from the execution of a non-nested function call. Since all configurations occurring along Lᵢ, where 0≦i≦k, have the same stack content, and since by the above discussion, each configuration need occur at most once along x, we see that for each control state d there can occur at most one configuration along Lᵢ, for any i, with a configuration in control state d. Thus Σᵢ|Lᵢ|≦|Q|, where |Q| is the number of control states of the PDS P.

Moreover since all executions of a function call must, by definition, occur from the same control state along L, and since, by the above observation, there can occur at most one configuration in a given control state, we have that there exists at most one non-nested execution of each function call along y.

Horizontal Bounding Lemma: Let x be a finite computation of a nested PDS P leading to control state c. Then, there exists a computation y of P leading to c such that y can be written as y=L₀N₀ . . . LₖNₖ where (a) Lᵢ is a (possibly empty) sequence of non-stack transitions, (b) Nᵢ is a sequence resulting from the execution of a non-nested function call, and (c) Σᵢ|Lᵢ|Q| and l≦|F|, where |F| is the number stack push transitions of P.

Vertical Reduction: The idea behind vertical reduction is that if there are two executions of the same function call, say, f cⁱⁿ:(xᵢ,x_{i′}) and fc^{out} with fcⁱⁿ nested within fc^{out}, i.e., i<j and either i′=∞=j′ or j′<i′, then we need only execute the inner one. The validity of the resulting computation follows from the fact that function calls and returns in a sequential program are nested. As a result, all function calls executed during a call must return before the call returns. Thus, the execution of function call that returns leaves the contents of the stack unchanged. In other words, executions of both fcⁱⁿ and fc^{out} leave the stack unchanged. Thus, if we execute fcⁱⁿ starting at xᵢ instead of fc^{out}, we end up in the same configuration, i.e., x_{i′}. All we need to show is that fcⁱⁿ can indeed be executed starting at xᵢ. Again, because of nesting all function calls that return during the execution of fcⁱⁿ must also have been called during the execution of fcⁱⁿ. In other words, the execution of any stack transitions during fcⁱⁿ does not depend on any stack transition that was executed before the call to fcⁱⁿ. All stack transitions fired during fcⁱⁿ depend only on the transitions fired along fcⁱⁿ. Thus fcⁱⁿ can indeed be fired starting at xᵢ.

Given a sequence x of configurations of P along which every stack pop transition has a matching push. Let (trⱼ,tr_{j′}) and (trₖ,tr_{k′}) be a nested pairs of push/pop stack transitions, respectively, resulting from the firing of the same function call of P. Let (trₖ,tr_{k′}) be nested in (trⱼ;tr_{j′}). Then j<k and either j′=∞ or k′<j′. Let y be the sequence x₀ . . . x_{j′},x_{k′+1} . . . xₙ resulting from x by executing the transitions tr_{k′} . . . trₙ₋₁ starting from xⱼ instead of the sequence tr_{j′} . . . trₙ₋₁.

Vertical Bounding Lemma: Let x be a finite computation of a nested PDS P leading to control state c. Then, there exists a computation y of P leading to c such that along x there does not exist matching push pop pairs pa₁=(trᵢ,tr_{i′}) and pa₂=(trⱼ,tr_{j′}) executing the same function call with pa₁ nested within pa₂ unless i′=∞ and j′<∞.

By leveraging the horizontal and vertical reduction lemmas, we can show the desired small model property for control state reachability. Let x be a computation leading to control location c. As described before, we start by parsing x as x=L₀N₀ . . . LₖNₖ, where Lᵢ is a (possibly empty) sequence of non-stack transitions and Nᵢ is a sequence resulting from the execution of a non-nested pair of matching push-pop transitions. From the horizontal bounding lemma, we have that Σᵢ|Lᵢ≦|Q| and k≦|F|. Thus |x|=Σ(|Lᵢ|)+Σᵢ(|Nᵢ|)≦|Q|+Σᵢ|Nᵢ|.

In order to prove the small model property, we have to bound Σᵢ|Nᵢ| for which we leverage the vertical bounding lemma. To bound the length of Nᵢ we can, as above, parse each Nᵢ=xᵢ₀ . . . xᵢⱼ as Nᵢ=Lᵢ₀Nᵢ₀ . . . LᵢₗᵢN₁ₗLᵢ₍ₗ_{ᵢ}₊₁₎ where Lᵢⱼ is a maximal sub-sequence of Nᵢ without a stack transition and Nᵢⱼ are segments resulting from the firing of a non-nested pair of matching push/pop transitions along the subsequence N′ᵢ=xᵢₒ₊₁ . . . xᵢⱼᵢ₋₁. Repeating the above procedure, we can recursively keep on breaking down a non-nested call N into smaller non-nested calls until we end up with a subsequence of x without any stack transitions. This enables us to construct a tree Tₓ with the nested calls as nodes.

Let N be a non-nested call encountered in the present procedure. If N is broken down as N=L₀N₀ . . . LₖNₖLₖ₊₁ then the children of N are precisely N₀, . . . ,Nₖ. Note that each Nᵢ is nested within N. Thus, each path in Tₓ starting at the root is comprised of a series of function calls such that each call is nested within its ancestors. A key observation is that from the vertical reduction lemma, it follows that along any path of Tₓ there cannot exist more than two nodes representing the same function call. The length of each path in Tₓ is at most 2d, where d is the call depth of the given program P. Since the number of distinct function calls is at most |F|, the length of each path in the tree is at most 2|F|.

With the node of Tₓ corresponding to the segment N=L₀N₀ . . . LₖNₖLₖ₊₁, we associate a weight which is the length Σⱼ|Lⱼ|, viz., the number of non-stack transitions fired along Nᵢ. Then, the length of x is bounded by the sum of weights of all nodes in Tₓ. As discussed above, Σⱼ|Lⱼ|≦|Q|. Thus, |x|≦|Q|(|Tₓ|), where Tₓ is the number of nodes in Tₓ. By the horizontal bounding lemma k≦|F|, i.e., the out-degree of each node is at most |F|. Let d be the maximum length of a path in Tₓ. Then total number of nodes in T is bounded by 1+|F|+|F|²+ . . . +|F|^{d-1}=O(|F|^{d}). Thus, the total length of x is at most |Q∥F|^{d}. By the vertical reduction lemma d≦|F|. Thus the total length of x is bounded by |Q∥F∥F| leading to the following result.

Theorem (Sequential Small Model Property): Let P be a nested pushdown system and let c be a reachable control state of P. Then, if c is reachable there exists a path x of P leading to c of length at most |Q∥F|^{2d}, where |Q| is the number of control state of P, |F| is the number of stack push transitions of P and d≦|F| is the maximum call depth in P.

Note that the vertical bounding lemma bound shows |F| to be an upper bound for d. In practicer however, the nesting call depth in a program is small, rarely exceeding 10, even though the number of functions can be quite large.

Generalized Sequential Small Model Property: The small model result allows us to bound the length of a path from the initial state of a PDS to a given control state c. For some applications, we are interested in constructing a smaller model y from x, while preserving not only the initial and final control states but also a given set of intermediate control states occurring along x. Formally, let xᵢₒ= [symbol] cᵢ_{₀},uᵢ_{ₒ} [symbol] . . . [symbol] cᵢ_{ₗ},uᵢ_{ₗ} [symbol] , where i₀< . . . <iₗ, be the configurations occurring along x whose control states need to be preserved. Our goal is to bound the length of a computation y having configurations yⱼ_{₀}= [symbol] cᵢ_{₀},vⱼ_{₀} [symbol] , . . . ,yⱼ_{ₗ}= [symbol] cᵢ_{ₗ},vⱼ_{ₗ} [symbol] , where j₀< . . . <jₗ, that preserve the control states of xᵢ_{₀}, . . . ,xₗ_{ₗ}, respectively. Note that we need that only the control states be preserved and not the stack content.

For simplicity, we start with the case when l=1, i.e., we need to preserve the control state of only one intermediate configuration, say xᵢ= [symbol] c,u [symbol] . If we naively apply horizontal and vertical reductions, then we might delete the configuration xᵢ which we want to preserve. In order to avoid deletion of xᵢ, we apply the reductions individually to the subsequences x¹=x₀ . . . xᵢ and x²=xₗ . . . xₙ of x. Applying the horizontal reduction presents no problems. However, in applying the vertical reduction we have to be careful about functions calls f c spanning xᵢ, viz., those that start executing before xₗ but finish after xᵢ along x. We have to ensure that in applying the vertical reduction if f c spans xᵢ then either both its call and returns are preserved or both are deleted. Additionally, there could be an unbounded number of function calls that span xᵢ= [symbol] c,u [symbol] , i.e., u it could be of arbitrary depth. Then, to produce a small model y for x, we start by limiting the depth of it. Using the vertical reduction result, we see, as before, that if there are two nested executions of the same function call spanning xₗ, then we need execute only the inner one. Thus there can be at most two executions of the same function call spanning xᵢ. In other words, the depth of it need be at most 2d, where d is the maximum call depth of P. Let xᵢ_{ₗ}, . . . ,xᵢ_{ₘ}, where iₗ< . . . <iₘ and m≦2d be such that xᵢ_{ⱼ} are the calling points of the function calls that span xᵢ and let xⱼ_{ₗ} . . . xᵢ_{ₖ}, where k≦m≦2d, be the matching return points for (some of) these calls. These call and return points decompose the path x into segments s⁰=x₀ . . . xₗ_{₁},s²=xₗ_{₁} . . . xᵢ_{₂}, . . . ,s^{m+2}=xₗ . . . xⱼ_{₁}, . . . ,s^{m+k+2}=xⱼ_{ₖ} . . . xₙ. All we need to do now is apply the small model property to each of these segments and then concatenate the resulting segments to get the desired small model.

Applying the small model result to each of the segments instead of the entire computation ensures that xᵢ and none of the spanning function calls are truncated. Since there are at most 2d+2 segments, and since by the small model theorem the length of each segment is at most |Q∥F|^{2d}, the total length of the resulting small model is at most (m+k+2)|Q∥F|^{2d}≦(2d+2)|Q∥F|^{2d}.

Now suppose that we need to preserve control states of a set C of configurations occurring along x instead of just one. We follow the same approach as in the case when |C|=1. The only difference is that instead of bounding the number of function calls that could span a single configuration, we need to bound the number of function calls spanning each subset of C. This is because the vertical reduction theorem can be applied to all functions that span exactly the same set of configurations of C. Two executions of the same function call with one nested inside the other that span a different set of configurations of C cannot be reduced via vertical reduction without deleting a configuration of C, i.e., the one not occurring in the inner call. As before, by applying the vertical bounding lemma, we have that there can be at most 2d calls spanning each subset of C. Since the number of subsets of C is |2^{C}| we have that the calls spanning subsets of C partition x into at most 2d|2^{C}|+2 segments the length of each of which is bounded by |Q∥F|^{2d}. The total length of x is therefore bounded by (2d|2^{C}|+2)(|Q∥F|^{2d}).

Generalized Small Model Property: Let P be a nested pushdown system and let x be a finite computation of P. Let xᵢ_{₀}= [symbol] cᵢ_{₀},uᵢ_{ₒ} [symbol] , . . ,xᵢ_{ₗ}= [symbol] cᵢ_{_{l,u}}ᵢ_{ₗ} [symbol] , where i₀< . . . <iₗ, be the configurations occurring along x. Then, there exists a finite computation y of P of length at most (2d|2^{C}|2)(|Q∥F|^{2d}) having configurations yⱼ_{₀}= [symbol] cᵢ_{₀},vⱼ_{₀} [symbol] , . . . ,yⱼ_{ₗ}= [symbol] cᵢ_{ₗ},vⱼ_{ₗ} [symbol] , where j₀<jₗ, that preserve the control states of xᵢ_{₀}, . . . ,xᵢ_{ₗ}, respectively.

Lock Causality Graph: Pairwise reachability is undecidable for two threads interacting purely via locks but decidable if the locks are nested. While nested locks account for most lock usage, there are niche, but critical, application areas like databases, concurrent programs using thread libraries (wait/notify in conjunction with mutexes), etc., where the nesting assumption does not hold. Non-nested usage of locks can be characterized in terms of lock chains

Lock Chains: Given a computation x of a concurrent program P, a lock chain of thread T of P is a sequence of lock acquisition statements acq₁, . . . ,acqₙ fired by T along x in the order listed such that if the matching release of acq₁ is fired along x it is fired by T after acqᵢ₊₁ and before the matching release of acqᵢ₊₁ along x.

Lock chaining is a trick used in database applications to enforce the execution of events in a pre-determined order which is not possible using nested locks. A feature of non-nested lock usage is that, in practice, it results in chains of bounded length. Indeed, most usage of locks is, in fact, non-nested which can be treated as chains of length 0. The two phase commit protocol used for serialization in databases uses chains of length 2 as do most interactions of thread library send and wait statements with mutex locks. The paradigm of bounded lock chains covers almost all cases of practical interest.

We show that pairwise reachability is decidable for programs comprised of threads interacting purely via locks when the lengths of all lock chains are bounded. We also show decidability of pairwise reachability for threads interacting via recursive locks. Since nested locks form chains of length 0, our new results are strictly more powerful than the existing state-of-the-art and make dataflow analysis tractable for a much broader class of programs.

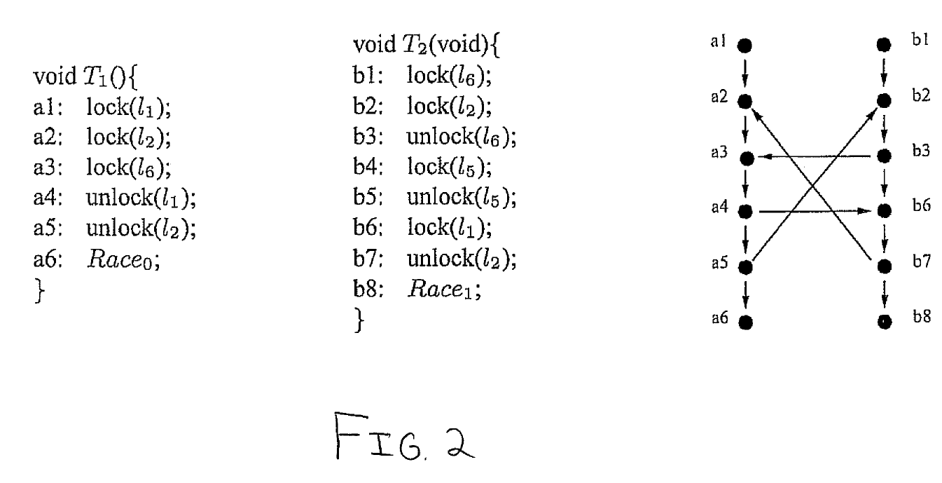

Pairwise Reachability for Non-nested Locks: We start by formulating a necessary and sufficient condition for pairwise reachability of control locations in two threads interacting via locks. We recall that for pairwise reachability of c₁ and c₂, disjointness of lock sets held at c₁ and c₂ is a necessary but not a sufficient condition. Consider the example concurrent program P comprised of threads T₁ and T₂ shown in FIG. 2. Suppose that we are interested in deciding whether a6 and b8 are simultaneously reachable. For that to happen, there must exist local paths x₁ and x₂ of T₁ and T₂ leading to a6 and b8, respectively, along which locks can be acquired in a consistent fashion. We start by constructing a lock causality graph G₍ₓ_{₁}_{,x}_{₂}₎ that captures the constraints imposed by locks on the order in which statements along x₁ and x₂ need to be executed in order for T₁ and T₂ to simultaneously reach a6 and b8. The nodes of this graph are (the relevant) locking/unlocking statements fired along x₁ and x₂. For statements c₁ and c₂ of G₍ₓ_{₁}_{,x}_{₂₎}, there exists an edge from c₁ to c₂, denoted by c₁→c₂, if c₁ must be executed before c₂ in order for T₁ and T₂ to simultaneously reach a6 and b8. The lock causality graph captures local as well as global causality constraints.

Local Causality Constraints: The local constraints encode the relevant lock chains in individual threads. As an example, consider local computation x₁=a1, . . . ,a6 and x₂=b1, . . . ,b8 of T₁ and T₂ leading to a6 and b8, respectively. We observe that at b8, T₂ possesses l₁ due to b6, the last statement to acquire l₁ before T₂ reaches b8. Then b6→b8 encodes the condition that in order to reach b8, T₂ must acquire l₁ at b6. Furthermore, since lock l₂ is held at b6, the last transition to acquire l₂ before b6, i.e., b2, must be executed before b6. Thus b2→b6. Similarly, b1→b2. Note that locks l₆, l₂ and l₁ form a chain.

Global Causality Constraints: (a) Consider lock l₁ held at b8. Note that once T₂ acquires l₁ at location b6, it is not released along the path from b6 to b8. Since we are interested in the pairwise reachability of a6 and b8, T₂ cannot progress beyond location b8 and therefore cannot release l₁. Thus, we have that once T₂ acquires l₁ at b6, T₁ cannot acquire it thereafter. If T₁ and T₂ are to simultaneously reach a6 and b6, the last transition of T₁ that releases l₁ before reaching a6, i.e., a4, must be executed before b6 resulting in the addition of a4→b6. (b) Global causal constraints can be deduced in another way. Consider the global constraint a4→b6. Note, that at location b6 lock l₂ is held which was acquired at b2. Also, once l₂ is acquired at b2 it is not released until after T₂ exits b6. Thus, if l₂ has been acquired by T₁ before reaching a4 it must be released before b2 (and hence b6) can be executed. In our example, the last statement to acquire l₂ before a4 is a2. The unlock statement corresponding to a2 is a5. Thus, a5→b2.

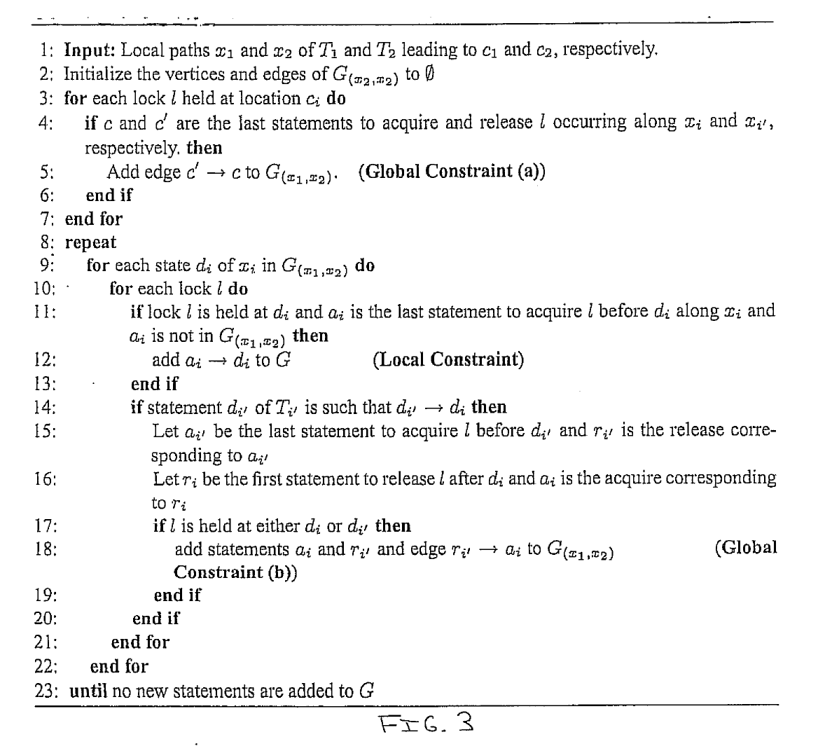

Computing the Lock Causality Graph: Referring to FIG. 3, given finite local paths x₁ and x₂ of threads T₁ and T₂ leading to control locations c₁ and c₂, respectively, the procedure (see FIG. 3) to compute G₍ₓ_{₁}_{,x}_{₂}₎, adds the local (steps 11-13) and global constraints (global constraint (a) via steps 3-7 and (b) via steps 14-19) one-by-one until we reach a fixpoint. Throughout the description of FIG. 3, for iε[1 . . . 2], we use i′ to denote an integer in [1 . . . 2] other than i. The causality graph G₍ₓ_{₁}_{,x}_{₂}₎ for paths x₁=a1, . . . , a6 and x₂=b1, . . . , b8 is shown in FIG. 2.

Necessary and Sufficient Condition for Reachability: Let x₁ and x₂ be local computations of T₁ and T₂ leading to c₁ and c₂. Since each causality constraint in G₍ₓ_{₁}_{,x}_{₂}₎ is a happens-before constraint, we see that in order for c₁ and c₂ to be pairwise reachable G₍ₓ_{₁}_{,x}_{₂}₎ has to be acyclic. In fact, it turns out that acyclicity is also a sufficient condition.

Theorem 1. Locations c₁ and c₂ are pairwise reachable if there exist local paths x₁ and x₂ of T₁ and T₂, respectively, leading to c₁ and c₂ such that G₍ₓ_{₁}_{,x}_{₂}₎ is acyclic. In order to apply the above result to decide pairwise reachability, we need the notion of the language induced by the lock statements that determine pairwise reachability.

Pairwise Reachability for Threads Interacting via Locks: We show that even though pairwise reachability is undecidable for threads interacting via locks, by exploiting programming patterns like recursive locks, nested locks and usage of bounded (non-nested) locks chain, we can for most cases of practical interest efficiently decide pairwise reachability.

Central to approach is to exhibit a small model property that allows us to bound the lengths of the paths that need be explored in order to deduce pairwise reachability. This, in effect, settles the problem for all the standard lock usage patterns that occur in real code.

Small Model Property for Threads Communicating via Nested Locks: a small model property for pairwise reachability for concurrent programs is comprised of threads synchronizing via nested locks. Let (c₁,c₂) be pairwise reachable and let x be a global computation of P leading to (c₁,c₂). We denote the local computations of T₁ and T₂ along x by y and z, respectively. Using the sequential small model property, we can reduce the lengths of y and z to produce shorter computations y′ and z′ leading to c₁ and c₂, respectively. However, by the acyclicity theorem, we have that c₁ and c₂ are reachable via local computations y and z of P₁ and P₂, respectively, if and only if G(y,z) is acyclic. Thus, in constructing y′ from y and z′ from z, we need to ensure that the acyclicity of the lock causality graph is not lost, i.e., G(y′,z′) is also acyclic.

Preserving Acyclicity of the Causality Graph via Path Decomposition: To preserve the acyclicity of the lock causality graph, we exploit the result that for a concurrent programs comprised of threads composed of nested locks, each global edge a→b, from y(z) to z(y) occurring in the causality graph G(y,z) is from the last statement releasing lock l to the last statement acquiring l along z(y), where l is held at c₂(c₁). Let C={yᵢ_{₀}, . . . ,yᵢ_{ₘ}} be the locking statements of G(y,z) occurring along y. Thus, in constructing a small model u for y, we preserve the control states of all the locking statements in C. By the generalized small model property, |u|≦(2d|2^{C}|+2) (|Q∥F|^{2d})≦(2d|2^{L}|+2)(|Q∥F|^{2d}), where |L| is the number of locks in P. Similarly, we can construct a small model w for z by retaining add all the locking operations of z occurring in G_{(y,z)}. Note that in creating the small models u and w for y and z, respectively, we retain the last locking statements for all the locks held at c₁ and c₂. It may happen, however, that the last statement to release a lock l along y(z), say tr, might have been deleted in constructing u(w). Thus the last statement to acquire l along u(w), say tr′, must occur before tr along y(z). In other words, the causality constraints in G_{(w,n)} are less strict than those in G_{(y,z)}. Thus, any interleaving of the transitions of y and z that results in a valid global computation reaching (c₁,c₂) can also be used to produce an interleaving of u and w leading to (c₁,c₂), the only difference being that transitions of y and z that have been deleted in constructing u and z are not executed. This immediately leads to the following result.

Theorem (Nested Small Model Property) Let C be a concurrent program comprised of nested PDSs P₁=(Q₁,Act₁,Γ₁,c₁,Δ₂) and P₂=(Q₂,Act₂,Γ₂,c₂,Δ₂) and let control states c₁ and c₂ of P₁ and P₂, respectively, be pairwise reachable. Then, there exists a path x of C leading to (c₁,c₂) of length at most (2d₁|2^{L}|+2)(|Q₁∥F₁|^{2d}^{₁})+(2d₂|2^{L}|+2)(|Q₂∥F₂|^{2d}^{₂}), where |Qᵢ| is the number of control states of Pᵢ,|Fᵢ| the number of stack push transitions of Pᵢ and dᵢ≦|Fᵢ| the maximum call depth of Pₗ.

Small Model Property for Threads Communicating via Recursive Locks: A recursive lock is a mutex lock that can be acquired multiple times by the thread that currently possesses it. Recursive locks are useful in situations where a thread might need to acquire the same lock multiple times, such as in recursive functions. A recursive lock is not released until each lock call is balanced with an unlock call. Thus, a release of a lock l happens only if n lockings of l are matched by precisely n unlockings of the same lock. Note that recursion in locks does not break nestedness, i.e., if locks are syntactically nested then acquiring them recursively preserves nestedness. Unlike the non-recursive case, there might be a finite, but unbounded, number of acquisitions of l before a release happens. Thus, if a lock l is held at cᵢ then it may not be the result of the last statement acquiring l rather the last statement acquiring l that does not have a subsequent matching release statement.

For the case of recursive locks apart from the set of locks held by a thread, we also need to track the number of times each lock has been acquired. Since a recursive lock can be (re-) acquired arbitrarily many times we cannot track the lockset information as was the case for non-recursive locks. In order to address this problem, we begin by showing that we can bound the number of times a lock needs to acquired recursively to reach a given state. This reduces the problem to the case of a finite number of non-recursive locks. A small model property is achieved as above and can be handled the same as above. Analogous to matched and nested function calls and returns, we define matched nested lock acquisitions and releases.

Matched Acquisition and Release: Given a computation x of a nested PDS P, we say that a lock acquisition transition trᵢ:acq(l) fired along x is matched by a lock release transition trⱼ=rel(l), where j>i, if trᵢ is the last lock acquisition of l along x such that the number of acquisitions and releases fired after xᵢ and before xⱼ along x are the same.

Nested Acquisitions: Let trᵢ and trⱼ be lock acquisition transitions that are matched by the lock release transitions tr_{i′} and tr′_{j′} respectively, along x (if along x a matching lock release transition does not exit for a lock acquisition transition trₖ then we denote its matching release transition by tr_{∞}). Then, the acquire/release pair (trⱼ,tr_{j′}) is nested within the pair (trᵢ,tr_{i′}) if i<j and either i′ is ∞ or j′<i′.

Non-Nested Acquisitions: A pair (trᵢ,tr_{i′}) of matching acquire and release transitions trᵢ and trᵢ′ fired along x is said to be non-nested if there does not exist another matching push/pop pair (trⱼ,tr_{j′}) such that (trᵢ,tr_{i′}) is nested within (trⱼ,tr_{j′}).

The following lemma states that lock acquisition/releases for the same lock need not be nested unless the inner one in matched and the outer one matched. The idea is similar to the vertical reduction lemma. If there are acquisition and releases of a lock l at the same location with one nested inside the other, then we need only execute the inner acquisition and release. This immediately yields the following result.

Theorem (Bounded Acquisition Depth): Given, a local computation x of a nested PDS with nested locks leading to control state c, and let acqₗ and relₗ be a pair of lock acquisition and release statements for lock l (there may exist multiple such pairs). Then, there exists a local computation y leading to a c such that along x there do not exist matching acquires and releases (trᵢ,tr_{i′}) and (trⱼ,tr_{j′}) such that (i) (trⱼ,tr_{j′}) is nested within (trᵢ,tr_{i′}) and either both i′, j′<∞ or i′=∞j′.

Let Pair₁ be the set of matching lock acquisition/release pair of statements for lock l in P. The above lemma implies that for each pair p matching acquisitions and releases of p can be nested at most once. Thus, if we take all pairs in Pairₗ into account we have that the number of times a lock need be acquired recursively is at most 2|Pairₗ|. Treating all recursive acquisitions of the same lock as acquisitions of different locks allows us to leverage the small model property for a finite number of non-recursive locks. Treating each recursive acquisition as acquisition of a different lock results in at most 2Σₗ|Pairₗ| locks. Then, using the nested small model property we have the desired small model property.

Bounded Lock Chains: We now abandon the assumption that locks are nested. In order to get decidability, we have to assume that the lengths of lock chains are bounded. If we allow lock chains of unbounded length, pairwise reachability becomes undecidiable. We show a small model property for pairwise reachability for concurrent programs comprised of threads synchronizing via nested locks. Let (c₁,c₂) be pairwise reachable and let x be a global computation of P leading to (c₁,c₂). We denote the local computations of T₁ and T₂ along x by y and z, respectively. Using the sequential small model property, we can reduce the lengths of y and z to produce shorter computations y′ and z′ leading to c₁ and c₂, respectively. However, by the acyclicity theorem, we have that c₁ and c₂ are reachable via local computations y and z of P₁ and P₂, respectively, if and only if G_{(y,z)} is acyclic. Thus, in constructing y′ from y and z′ from z, we need to ensure that the acyclicity of the lock causality graph is not lost, i.e., G_{(y′,z′)} is also acyclic.

Preserving Acyclicity of the Causality Graph via Path Decomposition: To preserve the acyclicity of the lock causality graph, we exploit the observation that for a concurrent program where lengths of chains are bounded by b the number of nodes in the causality graph is at most 2b|L|. Let C={yᵢ_{₀}, . . ,yᵢ_{ₘ}} be the locking statements of G_{(y,z)} occuring along y. Thus, in constructing a small model u for y, we preserve the control states of all the locking statements in C. By the generalized small model property, |u|≦(2d|2^{C}|+2)(|Q∥F|^{2d})≦(2d|2^{b|L|2}(|Q∥F|^{2d}), where |L| is the number of locks in P. Similarly, we can construct a small model w for z by retaining all the locking operations of z occurring in G_{(y,z)}.

Note that in creating the small models u and w for y and z, respectively, we retain all configurations of G_{(y,z)}. Thus, paths u and w will also generate the same lock causality graph, i.e., G_{(y,z)}=G_{(u,w)}. All we need to show now is that the number of nodes in the lock causality graph is at most 2b|L|. In steps 3-7 of FIG. 3, an edge is added from the last statement releasing a lock l along y(z) to the last statement acquiring it along z(y). Clearly there are at most |L| of these seed edges. We now consider all cross edges (between y and z) that are induced by each of these seed edges via steps 14-20. Let e be a seed edge. We start by observing that if e′:c′→d′ is an edge induced by e via FIG. 3, then either there exists a sequence of edges e₀:c₀→d₀, . . . ,eₙ:cₙ→dₙ, where (i) e₀=e, (ii) eₙ=e′, (iii) for each j, either dⱼ₊₁ is the last statement (occurring before dⱼ along x₂) acquiring a lock l that is held at dⱼ, or the first statement occurring after dⱼ along x₂ acquiring a lock l that is not held at dⱼ. Consider the sequence d₀, . . . ,dₙ For j,j′ we use dⱼ<ₓd_{j′} to denote the fact that dⱼ occurs before d_{j′} along path x with the statements d₁, . . . ,dₙ. From observation (iii), it follows that if δ:d₀dᵢ₁, . . . ,dᵢₖ is the maximal sub-sequence with the property that dᵢₖ<ₓ . . . <ₓdᵢ_{ₗ}<d₀ and for each iⱼ<j′<iⱼ₋₁, [symbol] (d_{j′}<ₓdᵢ_{_{l−1}}), then if dᵢ_{ⱼ} is a statement acquiring lock l then it is the last statement acquiring l before dᵢ_{ⱼ} along x. In other words, the sequence δ is a lock chain. Since, by our hypotheses such a chain cannot exceed length b we have that the number of configurations in δ occurring before d₀ are at most b. Similarly one can prove that these can be at most b configurations occurring after d₀ along x. Each seed edge induces at most 2|L| edges. Thus, the total number of edges induced is 2b|L| thereby proving our claim.

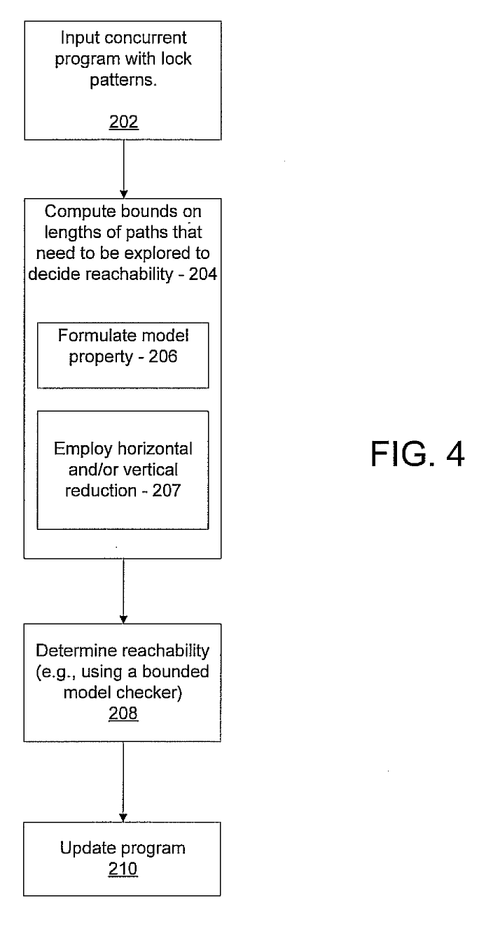

Referring to FIG. 4, a system/method for deciding reachability includes inputting a concurrent program having at least one pair of locations in two threads interacting via locks for analysis in block 202. In block 204, bounds are computed on lengths of paths that need to be explored to decide reachability for lock patterns. This may include formulating a model property for pairwise reachability that bounds lengths of paths that need to be traversed for a given pair of control states (c₁,c₂) to be reachable in block 206. The lock patterns preferably include at least one of a bounded lock chain and a recursive lock structure.

In block 207, at least one of a horizontal bounding reduction and a vertical bounding reduction is applied to limit a total length of a computation path needed to reach a control state c.

In block 208, reachability is determined for the pair of locations using a bounded model checker. This may include unrolling the program up to a depth formulated by the model property. Advantageously, reachability is decidable for threads interacting via nested locks and non-nested locks.

In block 210, the program is updated in accordance with a reachability determination. The program is fixed to remove conflicts such as data races or to others correct problems. This may be performed manually by a user or automatically via a computer/software.

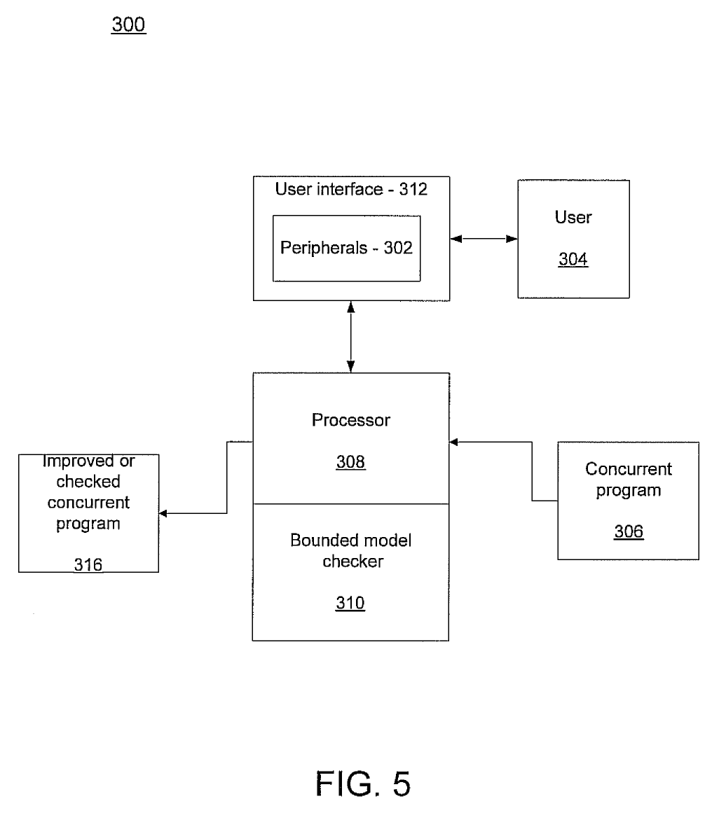

Referring to FIG. 5, a system 300 for deciding reachability is illustratively shown. The system is preferably implemented with hardware elements such as a computer processor or processors which are controlled or function in conjunction with software elements. The system 300 may be part of a debugging or program checking work station and may include peripheral devices 302 (e.g., key board, mouse, display, etc.) for interaction between a user 304 and the system 300. The system 300 receives as input a concurrent program 306 having at least one pair of locations in two threads interacting via locks. The locks are employed as described in the above analysis to apply a depth-wise analysis for pairwise reachability in the program.

A processor 308 receives the concurrent program for analysis. The processor 308 performs the needed operations for computing bounds on lengths of paths that need to be explored to decide reachability for nested and non-nested lock patterns. The lock patterns may include a bounded lock chain and/or a recursive lock structure. The processor preferably formulates a (small) model property for pairwise reachability that bounds lengths of paths that need to be traversed for a given pair of control states (c₁,c₂) to be reachable.

A bounded model checker 310 may be included in the processor or may be provided as a separate device or module and called by the processor when needed. The bounded model checker 310 is configured to determine reachability for the pair of locations using the characterization for the lock patterns to convert the normally undecidable problem to a decidable one. The bounded model checker only needs to unroll the program up to a depth formulated by the model property. The bounded model checker 310 may employ a horizontal bounding reduction and/or a vertical bounding reduction to limit a total length of a computation path needed to reach a control state c.

A user interface 312, which includes peripherals 302 is configured to update the concurrent program and repair bugs in accordance with a reachability determination. In this way, the checked concurrent program is output 316 as an improved program (or checked) for execution in any number of useful applications.

Having described preferred embodiments of a system and method for decidability of reachability for threads communicating via locks (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for deciding reachability, comprising:
inputting a concurrent program comprised of threads interacting via locks for analysis;
computing bounds on lengths of paths that need to be explored to decide reachability for lock patterns by assuming bounded lock chains;
determining reachability for a pair of locations using a bounded model checker; and
updating the program in accordance with the reachability determination.

2. The method as recited in claim 1, wherein the lock patterns include at least one of a bounded lock chain and a recursive lock structure.

3. The method as recited in claim 1, wherein computing bounds includes applying at least one of a horizontal bounding reduction and a vertical bounding reduction to limit a total length of a computation path needed to reach a control state c.

4. The method as recited in claim 1, wherein determining reachability for the pair of locations using a bounded model checker includes unrolling the program up to a depth formulated by a model property.

5. The method as recited in claim 1, wherein the locks includes at least one of nested locks, non-nested and a combination thereof.

6. A system for deciding reachability, comprising:
a concurrent program having at least one pair of locations in two threads interacting via locks;
a processor receiving the concurrent program for analysis, the analysis includes computing bounds on lengths of paths that need to be explored to decide reachability for nested and non-nested lock patterns;
a bounded model checker configured to determine reachability for the pair of locations; and
a user interface configured to update the concurrent program and repair bugs in accordance with a reachability determination.

7. The system as recited in claim 6, wherein the processor formulates a model property for pairwise reachability that bounds lengths of paths that need to be traversed.

8. The system as recited in claim 7, wherein the bounded model checker unrolls the program up to a depth formulated by the model property.

9. The system as recited in claim 6, wherein the lock patterns include at least one of a bounded lock chain and a recursive lock structure.

10. The system as recited in claim 6, further comprising a horizontal bounding reduction and a vertical bounding reduction employed by the model checker to limit a total length of a computation path needed to reach a control state c.

11. A computer readable medium comprising a computer readable program for deciding reachability, wherein the computer readable program when executed on a computer causes the computer to perform the steps of:
inputting a concurrent program comprised of threads interacting via locks for analysis;
computing bounds on lengths of paths that need to be explored to decide reachability for lock patterns by assuming bounded lock chains;
determining reachability for a pair of locations using a bounded model checker; and
updating the program in accordance with the reachability determination.

12. The computer readable medium as recited in claim 11, wherein the lock patterns include at least one of a bounded lock chain and a recursive lock structure.

13. The computer readable medium as recited in claim 11, wherein computing bounds includes applying at least one of a horizontal bounding reduction and a vertical bounding reduction to limit a total length of a computation path needed to reach a control state c.

14. The computer readable medium as recited in claim 11, wherein determining reachability for the pair of locations using a bounded model checker includes unrolling the program up to a depth formulated by a model property.

15. The computer readable medium as recited in claim 11, wherein the locks includes at least one of nested locks, non-nested and a combination thereof.
